(19) United States
(12) Patent Application Publication
(10) Pub. No.: US 2009/0313077 A1
(43) Pub. Date: Dec. 17, 2009

(54) Consumer initiated, service provider direct dispatching system

(76) Inventor: George Y. Wheeler, IV, Dallas, TX (US)

Correspondence Address: HOLLAND & KNIGHT LLP, 2099 PENNSYLVANIA AVE, SUITE 100, WASHINGTON, DC, 20006, US

(21) Appl. No.: 12/453,780

(22) Filed: May 21, 2009

Related U.S. Application Data
(60) Provisional application No. 61/073,107, filed on Jun. 17, 2008.

(51) Int. Cl. G06Q 10/00; G01C 21/00; G06Q 30/00; G06Q 50/00

(52) U.S. Cl. 705/9; 705/11; 700/300; 705/26

(57) ABSTRACT

A customer originated and directed dispatching system to provide direct coordination of requested service to service providers without the need for intermediary dispatching assistance. A database stores records each documenting needed services and customer and service provider profiles. Processing circuitry (which may be one or several networked computers) performs a dispatching process which reviews these records, locates records indicating a need for immediate service, locates the customer, identifies potential service responders, carries out an auction for the requested service and collects a list of potential service provides with their bids and profiles. The processing circuitry also performs a monitoring process which monitors service provider's activities by reviewing the records, and automatically obtained service provider's activity information, and records customer and service provider performance ratings to the database. Communications circuitry enables direct communication between the service provider and the customer as well as updates of the service provider's activity and review customer and service provider performance records.

### FIELD OF THE INVENTION

The present invention relates to coordination of mobile services to a mobile customer location.

### BACKGROUND OF THE INVENTION

There are a number of dispatching systems that enable dispatchers to better coordinate service requests with available responders. Many systems employ a simple as two-way radio system with broadcasts requests to all parties and as sophisticated as GPS enabled tracking systems and computer databases which calculate future availability, location optimization and utilization factors to better employ fleet resources. These systems are primarily intended to help dispatchers better coordinate the activities of their entire fleet. They assist dispatchers in identifying the location of taxicabs, schedule vehicle requests, monitor fleet utilizations and help maximize the effectiveness of each resource in the fleet.

Each taxi fleet is made up individual self interested drivers who pay the dispatcher a fee to be included in their dispatching network. The relationship between the dispatcher and the taxi driver is mutually dependent but each party has different priorities. The dispatcher wants to effectively respond to passenger requests and consider the priorities of the entire taxicab company, but the driver is primarily focused on his own utilization. A degree of distrust is naturally inherent in a system which lacks transparency into the dispatching process. Taxicab drivers do not control the dispatching process or even select the passengers that they are assigned. As a result, it is common practice for taxicab drivers to pay a minimal fee to hotel bellhops to direct the best customers to their taxicab. The successful operation of a taxicab depends on maximizing the number of paying fare which necessitates finding the next fare with least amount of investment of time. Taxicab drivers must consider the likelihood of a fare at one location versus another. They are dependent on their ability to identify passengers in line of sight of their vehicle and respond to service requests from their dispatcher. In addition, the driver must be aware of the risk of robbery and homicide inherit with working alone and carrying large amounts of cash. In a recent survey of work related fatalities, taxi drivers ranked 10^{th} in number of fatalities per capita of any occupation. The increasingly sophisticated dispatching systems have made the dispatcher's job easier by automating many of his tasks, but the cost of these high technology systems has increased the operating expense to drivers without providing additional value to them. As a result, the driver evaluates factors that diverge from those of the dispatcher to ensure his success.

The passenger is not particularly well served in the current system as well. Hailing a taxicab has not made very many improvements since the wide acceptance of two way communication in the taxicab industry. Taxicabs may be hailed by waiting on the sidewalk for an available taxi to drive by, a taxi stand or calling a taxicab company. The effectiveness of each process depends on a number of factors. Hailing a taxicab on the street depends on the available taxicabs driving in close proximity to identify the passenger. This method is further exacerbated by weather conditions and safety concerns and may demand an investment of time to identify an available taxicab. A taxi stand depends on the passenger's knowledge of the availability of taxicabs at the taxi stand and the location of the nearest taxi stand. Lastly, contacting a taxicab company is predicated on the passenger knowing the number of a taxicab company and being able to identify their current location. In addition, contacting a taxicab company only communicates your request to available taxicabs of the contacted taxicab company which may or may not be the nearest available taxi. As a result, the passenger may be waiting longer than necessary for a taxicab.

Assuming that an available taxicab can be identified, the current method of taxi dispatching does not address a number of additional issues. Typically, a taxicab company will identify an approximate time of arrival and will anticipate that the passenger will be waiting at their location for immediate receipt of the taxicab. The passenger does not know exactly when the taxicab will arrive and as a result will wait outside exposing himself to the weather and safety concerns associated with standing by the street. In addition, the passenger is uninformed about the qualification of the taxicab driver and his previous performance record. The passenger is expected to enter the next taxi without so much as knowing the name of the drive let alone the condition of his vehicle and the level of service that might be expected.

The coordination of a fleet of taxis demands a number of simple steps. The service requests must be received, available taxis must be located, a single vehicle must respond to the request for service and the dispatcher needs to monitor the process that the request is fulfilled.

A variety of systems have been employed to carry out these steps. Simple, less expensive manual systems utilize two way radio systems and demand a high degree of dispatcher involvement. Sophisticated computerized system which depend on the installation of GPS system, computer with monitor and communication capability in the vehicle facilitate the dispatcher's job, but are expensive to purchase and maintain.

These sophisticated systems manage the receipt and posting of service requests through a system of databases and processors to record needed services and transfer these requests and route information to vehicle based systems. They track the activity of vehicles and offer real-time activity data on the vehicle via satellite navigation systems. The dispatcher uses the information gathered to make decisions on how best to respond to service requests. The most advanced systems identify the best vehicle to respond to a request and automatically dispatch them to the requested location.

### SUMMARY OF THE INVENTION

Despite the high degree of sophistication of these systems, they have been focused primarily on assisting the dispatcher facilitate his job rather than respond to the needs of the passenger and drivers.

For the taxicab drivers to maximize their profits, they want to reduce their operating expense, increase the number of fares and ensure their own safety. The current offering of dispatching services facilitates the job of the dispatcher, but increases the cost to the driver, thereby reducing his profitability. The currently available dispatching systems do not permit the drivers to choose their own fares. They merely respond to the requests forwarded by the dispatcher. If the taxicab is available, he will be dispatched automatically without inquiry or input in the decision. Lastly, taxicab drivers want to maximize the number of fares. The current system limits the drivers to being dispatched by calls only to his taxicab company. A taxicab driver could increase their ridership by finding addition means of dispatch.

From the passenger's perspective, the dispatching system limits the availability of taxicabs, exposes the passenger to inclement weather and dangerous conditions, provides inadequate information about the taxicab driver's historical performance, and lacks direct customer monitoring and communications capabilities with the drivers. The current systems only dispatch taxicabs within the network of taxicab company regardless of availability of other taxicabs. The current systems demand that the passenger wait for the taxi by the street for a taxi to arrive during an approximated period of time. In other service industries, the service provider and customer mutually select each other rather than just being based on the service provider's relative proximity to the customer. For example, a customer would never choose a cleaning lady, electrician or house painter just because they are nearest to your home. Lastly, the passenger in all previous systems does not have direct access to the monitoring capabilities of the dispatcher nor do they have the means to communicate directly with the driver.

The present invention addresses the shortcoming of these vehicle dispatching systems by providing the passenger and taxicab driver a low cost direct access to each other without the interference of a taxicab company dispatcher. The invention provides complete transparency into the dispatching process.

The present invention permits the passenger to request a taxicab without knowing the phone number of a taxicab company in that city, allows him to select the taxicab based on a list of available taxicabs in his area based on their fares or estimate time of arrival bid and the historical performance of the taxi driver, enables the passenger to track the activity of the dispatched taxicab and know with a high degree of certainty the precise moment that the taxicab has arrived, permits the passenger to wait safely indoor until the monitoring system indicates that the driver is at the location, and allows the passenger to rate the performance of the taxicab driver so that the taxicab driver's profile includes the most recent performance of his duties.

The present invention also alleviates the shortcomings from the driver's perspective by demystifying the dispatching process, reducing the dangers and additional costs associated with an expensive dispatching system and providing an additional means of receiving fares. The current invention identifies a group of available taxicabs in the vicinity of the passenger and allows them to bid for the fare. They are able to decide for themselves if they want to bid based on the passenger profile and their historical trip history and driver satisfaction score. As a result, they have greater flexibility and a degree of security because the passenger is a registered user of the service rather than anonymous client. In addition, the dispatching system does not rely on a high cost installed system that increases his operating cost and reduces his profitability. Lastly, the present invention provides additional dispatching opportunities that can increase the number of fares.

The invention features a system for the dispatching service responders to provide service to customers. Exemplary embodiment of the present invention include a database that receives service requests from customers which are located by the system using satellite or network based technology using their cellular phones.

In the exemplary embodiment, the system reviews the requests and identifies a group of available service providers that could potential service the customer. This is communicated to the group of potential service responders and carries out an auction process. The auction process consists of each service provider offering a bid for the service request without knowledge of the bid of other responders. The bid offers and the profiles of the group of potential service responders is communicated to the customer using the communication circuitry and the customer reviews the offers and service providers' profiles to select his preferred provider. The consumer maybe looking for a service provider with specific attributes. For example, the consumer might select a driver based on his vehicle capabilities. The selected service provider is alerted that he has been selected and is directed to the location of the customer. The monitoring system can track the activity of the selected service provider and the customer may monitor the selected service provider's activity. The passenger may communicate directly with the driver through the system through a double blind communication system that keeps confidential information like the cellular phone number from the other party. The processing circuitry can update the profile of all parties based on performance. The system allows each party to answer a satisfaction survey on the other party which might include cleanliness of the vehicle and helpfulness of the driver. The driver's timeliness can be calculated based on their ability to meet their own estimates of arrival time.

The system can include processing circuitry such as a microcomputer running a multitasking operating system, a network of computers, or any other arrangement of computing hardware, including an arrangement of computers spread geographically in a wide-area network. There may be multiple processes to dispatch and monitor service providers, running simultaneously on networked computers or in a multitasking operating system.

The communications may use ground-based radio communication, satellite-based radio communication, or both. In particular, satellite-based vehicle tracking circuitry may be used to track the locations of the service provider, and the service provider locations forwarded via satellite or radio to the processing circuitry for use in vehicle monitoring.

The monitoring system may evaluate the vehicle's movements and position to determine its progress to the appointed location. Alternatively, or in addition, the service provider may manually communicate his arrival at the appointed location.

Requests for service may be entered by passengers directly into the database, or may be entered remotely via a website.

The automated dispatching and controlling system not only collects service request and activity information, but also collects billing information associated with requested services from the user's profile. When the service request is completed, this information can be used to automatically generate a electronic invoicing for the services rendered.

The system can also be used to monitor the activity of the service provider, e.g., whether the vehicle is moving, the velocity and direction of the service provider. This information can be used to determine, in a more detailed manner, the progress of the service responder.

The collection of information on current service provider status and future appointments can be combined to provide continual, automated system status management, to determine and predict future needs for transportation services and compare the future needs to expected availability of service providers.

This description focuses on taxi dispatching, but this invention may be employed in any activity that demands mobile users to coordinate with other mobile resources. There are numerous other applications like roadside assistance vehicles that employ vehicles, but this invention may also be employed outside of the transportation field. For example, this system maybe employed within a hospital that employs a large number of resources with varying level of expertise in a number of fields. This system could dispatch needed personal based on their qualifications for a needed service. The system could locate needed resources and dispatch the group to respond in this most effective manner. The profile of each user includes their expertise and qualifications and might be employed to utilize and personnel resources of the facility at the most effective way.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a diagram of a consumer initiated, service provider direct dispatching system in accordance with principles of the present invention;

FIG. 2 is a flow chart of the operations performed by a Dispatching process of FIG. 1;

FIG. 3 is a flow chart of the operations performed by consumer location process of FIG. 1;

FIG. 4 is a flow chart of the operations performed by the registration process;

FIG. 5 is an illustration of the various data files stored by the server in FIG. 1 and manipulated by the dispatching, location, communications and bidding processes;

FIGS. 6A, 6B, 6C, 6D and 6E are illustrations of the formats of the data files illustrated in FIG. 5

### DETAILED DESCRIPTION OF SPECIFIC EMBODIMENTS

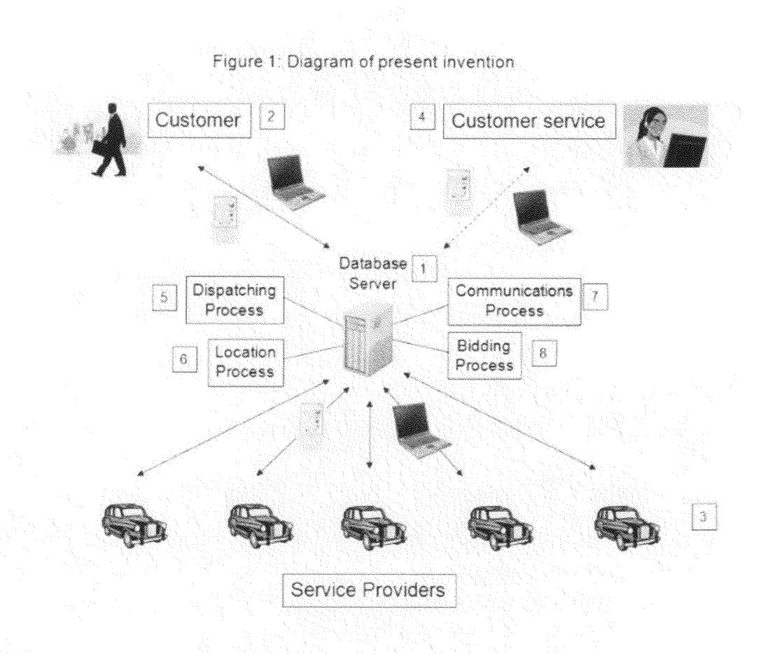

Referring to FIG. 1, an example of a Consumer initiated service provider direct dispatching system as described in the background and summary above, is a system for the coordination of service providers to respond to needed service requests. Specifically, the example system includes a database server (1) for storing records indicating requested services, user profiles and associated information. This database can be populated by various sources, such as, consumers (2) and service providers (3).

Service request maybe made a variety of ways. For example, consumers and service providers can access and update their account through their cellular phone or over the internet.

In known dispatching systems described in the background of this application, dispatchers enter requests into the dispatching system, dispatch the service providers or oversee an automatic dispatching process. For example, Smith et al. employ human dispatchers to enter service requests or allow “contract customer” may enter request using “remote entry terminals” or touch tone phones. However, in accordance with the principles of the present invention, customers would access the database and communicate directly with perspective service providers. Under normal circumstances, the interactions with database server (1) and service providers are at the discretion of the service providers and customers and are performed by communications processes (7), dispatching processes (5), location processes (6), and bidding processes (8) which locates perspective service providers, collects their best offers, presents the offers and profiles, monitor services providers and facilitates the communications between the parties in response to orders reflected in records and database (1).

In accordance with embodiments of the present invention, customer service representatives (4) only enter service requests or interact with database server (1) when location based process fails to locate the customer. This infrequent interaction with system is represented by dotted lines between customer service representatives (4) and the database server (1).

Under normal circumstances, as will be explored more fully below, customer service representatives (4) only interact with the service providers under unusual circumstances. Customer service representatives (4) do not monitor customer service requests or activities. Typically, customer service representatives (4) will not typically be actively involved in the dispatching process.

The following Figures and description illustrate exemplary operations of the dispatching process (5), location process (6) communication process (7) and bidding process (8) to permit the service providers and customers to directly coordinate their service requests dispatching.

A number of commercially available, cellular phone tracking applications could be employed in this system. For example, the Google maps my location application may be utilized to locate the cellular phone of the service provider and customer for the purposes of this invention.

In this embodiment, the system assumes the employment of cellular phone technology to enable the data entry into the database server (1) and communication between parties by means of voice, internet and texting capabilities of the cellular phone system. It includes a given automated dispatching system that may in turn include multiple communications processes (7), dispatching processes (5), bidding processes (8) and location processes (6), running independently in networked computing systems. Thus, FIG. 1 illustrates a multiplicity of each process active in the dispatching system. In the following discussion, the flow charts and operations of each of the communications, dispatching, bidding and location processes will be elaborated with an understanding that multiple processes could be in simultaneous operation at any given time and processing dispatching records in server (1) simultaneously.

It is further contemplated that various aspects of the automated dispatching system could, but do not need to be, separated physically from one another; so, for example, database server (1) may be at a geographically central location whereas the computing systems running the communications, dispatching, bidding and location processes may be remotely located and communicating with database server (1) over a wide-area or Internet network through the above-described communications facilities.

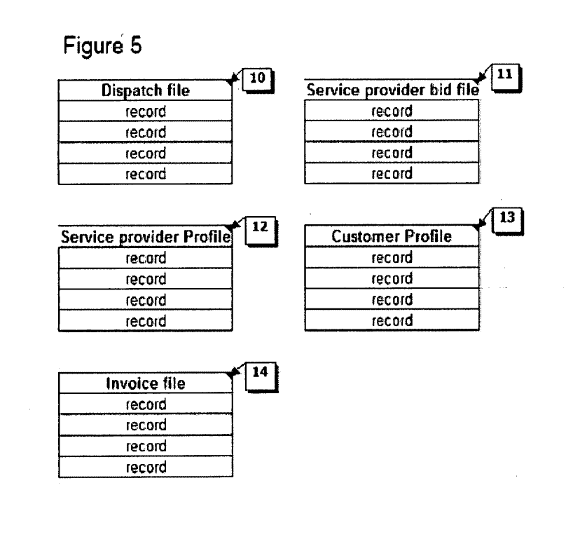

Now turning to FIG. 5, the various exemplary data files used during the dispatching, location and bidding processes (5,6, and 7) to locate, select and track the service request. The dispatch file (10) is the primary file to store information regarding a service request and the status of service provider selected for the request and to interact with other processes in the dispatching system.

In the illustrated embodiment, voice file (14) contains information for generating an invoice for service requests performed by service providers (3) upon customer request. Invoice files (14) contain detailed information used to generate detailed invoices. Service Provider Profile (12) and Customer profile (13) can be used to search and identify service history of service providers and customers, as discussed below.

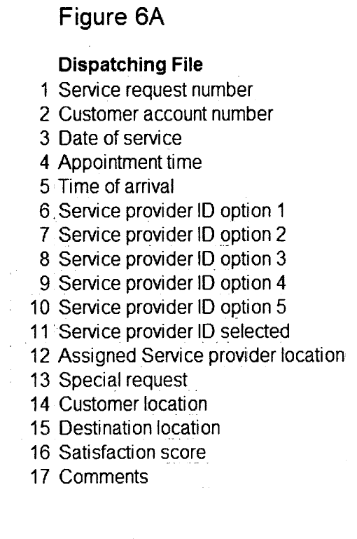

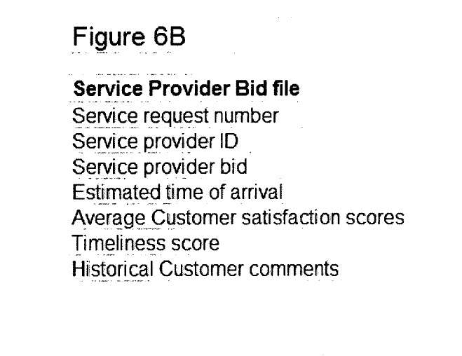

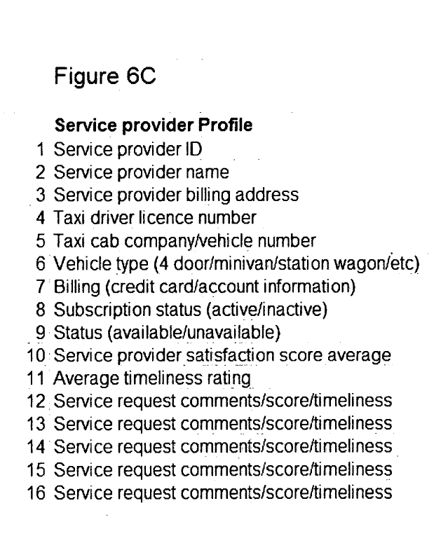

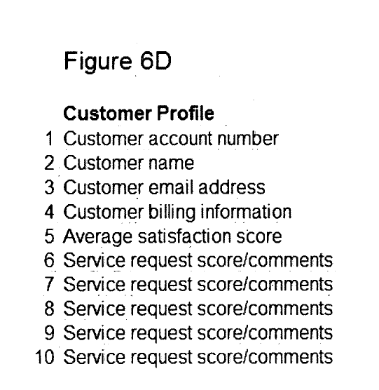

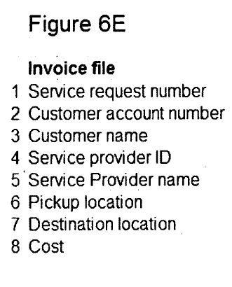

FIGS. 6A through 6D illustrate exemplary file and data communications formats that can be used in one embodiment of the present invention to generate and update the files illustrated generally in FIG. 5. Specifically, FIG. 6A illustrates an exemplary format of records in dispatch file (10). FIG. 6B illustrates an exemplary format of records in service provider bid file (11). FIG. 6C illustrates an exemplary format of records in Service Provider Profile (12). FIG. 6D illustrates an exemplary format of records in Customer profile file (13). FIG. 6E illustrates the format of records in invoice file (14).

The use of the files illustrated in 3A-3R-2 will be illustrated in further detail below in connection with FIGS. 6A-6E. Initially, in this embodiment, it should be noted that dispatch file records can be generated by the customer (2) or Customer service representative (4), as part of requesting service. When the customer or customer service representative creates the dispatch record, the terminal or server through which the person (2 or 4) is interacting can generate a dispatch record of the format shown in FIG. 6A, which record can be stored in database server (1).

In this illustrative embodiment, when a request for service is made, a service request number is assigned to that request to identify the request within the system. The request number can be a combination of the account number of the client which is assigned to the individual during registration followed by a sequential number which identifies the specific service request. The dispatch file can also be assigned to the customer's account number in the second field.

The customer enters the required data points into the database server. This information is stored respectively in the third and fourth field of the dispatch file record. The customer may chose for the service request to be filled immediately or enter an appointment time in the future.

The data entry person (2 or 4) can also identify particular information for the service request. For example, the type of vehicle maybe indicated in the thirteenth field. For example, the customer may request a vehicle of a specific size based on the anticipated number of passengers or bags.

The dispatching file can record the actual time of arrival of the vehicle in field 5. This field helps determine the timeliness of the driver vis-a-vis this predicted arrival time. This information can be used to determine how effectively the service provider is in arriving at the location of the customer in relation to the time he predicted he would arrive at the customer location.

In the illustrated embodiment, the dispatching file includes fields (6-10) to include the service provider ID numbers of service providers who are short listed to bid on the service request. The list of potential service providers can be based on proximity or other parameters that may include the type of vehicle desired for the request. These providers may bid for the service request. Field 11 of the dispatch file is the service provider ID of the service provider selected by the customer to carry out the service request. The dispatching file can be used to record the last known location of the selected service provider in field 12. This field tracks the location and progress of the selected service provider in responding to the service request. Field 14 is based on the location process which locates the customer based on his cellular phone location. The destination location (field 15) may be entered by the customer or be determined based on the location of the customer following the completion of the service request. Fields 16 and 17 can be used to track the satisfaction of the customer of the service provider's performance. A satisfaction score and comments pertaining to the performance of the service provider specific to the service request can be recorded in these fields.

Once a data entry person 2 or 4 creates a dispatch record as described above, the dispatch processes (5-8) can automatically initiate the service provider selection process in accordance with the parameters set forth in the dispatch record. As these events occur, the automated dispatch processes (5-8) can be used to fill out fields 5-12, 14 and 15 of the dispatch record to indicate the short-listed service providers, the service provider selected, the location of the selected service provider, the customer location and under some circumstances the destination location. As a result, all of this information is available to generate detailed invoices for delivery to the customer of sufficient detail.

During the dispatching process, a group of service providers are short-listed to bid for a service request. FIG. 6B illustrates the service provider bid file that tracks the individual bids offered by each service provider. The service providers may be short-listed by various means including customer satisfaction, the type of vehicle requested or proximity to the customer. The Service provider ID number of the bidding service provider can be recorded in field 2. The bid process (8) permits the drivers to propose the estimated time of their arrival or the price of the service to the customer. The service provider's estimate time to arrive at the customer location is recorded in field 3. An estimated time of arrival can be calculated and entered automatically in field 4. Historical performance indicators and comments can be recorded in fields 5-7. The information in Fields 4-7 can be forwarded to the customer for his consideration. It is anticipated that service provider bid file would be created for each short-listed service provider in parallel.

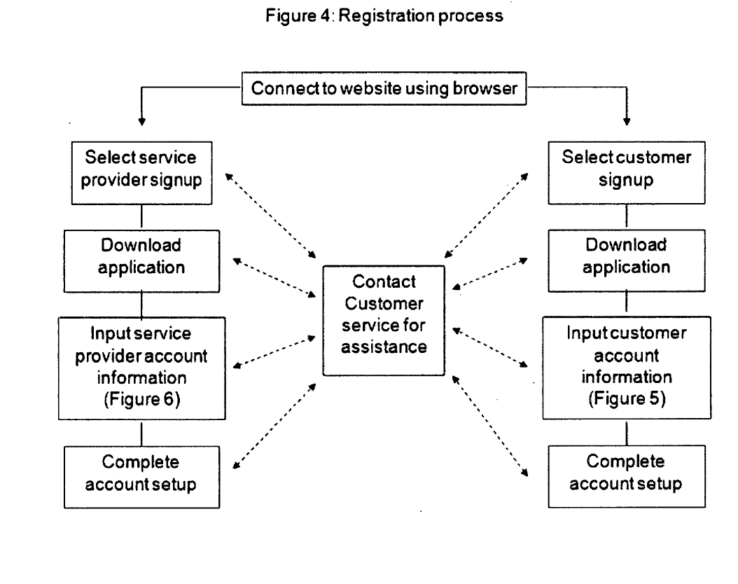

In this embodiment, each registered service provider has a service provider profile file (FIG. 6C). During the registration process (FIG. 4), a service provider creates his profile and may update the fields online or through his cellular phone. The service provider must enter during the registration process field 2-8 which include his name, billing address, billing information to enable payment directly to the driver, taxi license number, taxicab company name and vehicle number, vehicle type and means of payment. The subscription status (field 9) is whether the subscription is current meaning that he has paid to be listed in the service. The driver may select (field 10) based on his availability whether he will receive dispatching calls or suspend service request because he is currently on call with another service request. A service provider ID number (field 1) is assigned during the registration process as a means of tracking the service provider within the system. Field 11 and 12 are averages of performance rating based on previous service requests that have been entered into the system by customers. The individual customer satisfaction scores, performance indicators and comments on the service providers historical performance are recorded on an individual basis in fields 13-17. Any aspect of historical performances can be recorded; the inclusion of only five fields is merely illustrative.

Referring to the illustrative profile in FIG. 6D, each customer can create a customer profile during the registration process. The illustrative registration process shown in FIG. 4 is completed online. To initiate the registration process, the user initial selects whether they are a service provider or customer. The customer inputs the data that will initially comprise his profile. The user can input his brand and model of cellular phone using, for example, a pulldown menu and the system queries the user to download to his cellular phone the appropriate application. Following downloading of the application, the system can test the application by sending a message to the cellular phone confirming that the application has been properly installed.

As illustrated, the customer profile can be used to track the previous customer usage of the system and permit the service providers to record their satisfaction scores and comments on the customer's service requests. A customer account number (field 1) can be assigned during the registration process as a means of tracking the customer's service requests within the system; and the customer can enter his name (field 2) during the registration process. The customer may enter his billing address and billing information (credit card) into the profile to enable direct billing of service requests using the system. An average service provider satisfaction score (field 5) is calculated based on an average of the scores awarded by the service providers following the completion of the service request. Individual scores and comments are available for review for each historical service request by the service provider (field 6-10). Any aspect of historical performances can be recorded; the inclusion of only five fields is merely illustrative.

Upon completion of a service request, an invoice can be generated based on the invoice file (FIG. 6E) and customer and service provider profile data. The information on the invoice depends upon the particular desires of the installation. It can include, for example, the name of the customer and service provider, mileage, pickup and destination locations, and the cost of the trip based on the rates of the municipality. The invoice maybe emailed to the email account included in the customer profile or access using the website.

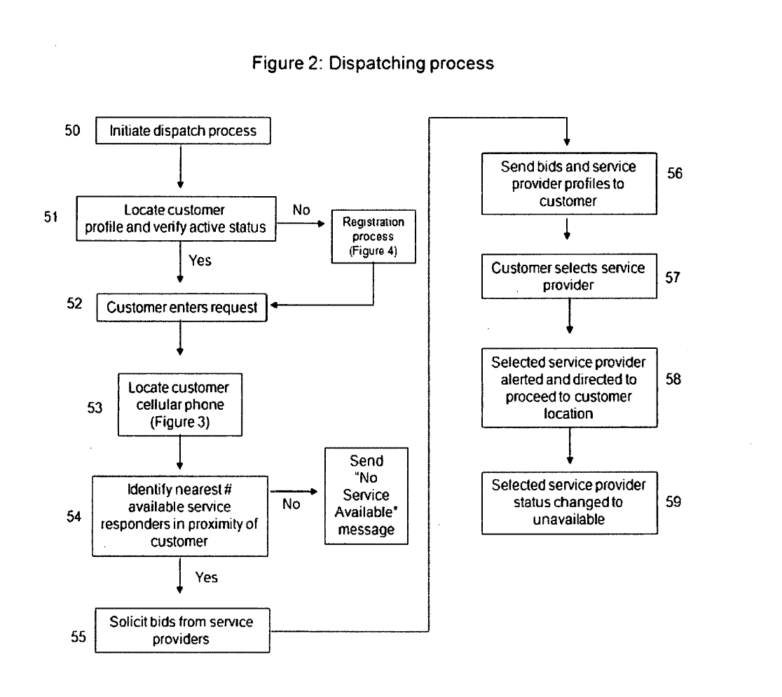

The detailed functions of the dispatching processes (5-7) as illustrated in FIG. 2 are an illustration of the dispatching processes (5). At the beginning of this process, the dispatch file (10) is opened (50) to permit evaluation of dispatch request. Next, the dispatching process (5) extracts the customer profile data (FIG. 6D) to determine whether the customer account is active (51) and populate the service request with customer data. Failing to locate the customer's profile the process initiates the registration process (FIG. 4). Following account verification, the customer indicates the date and time of the service request (52).

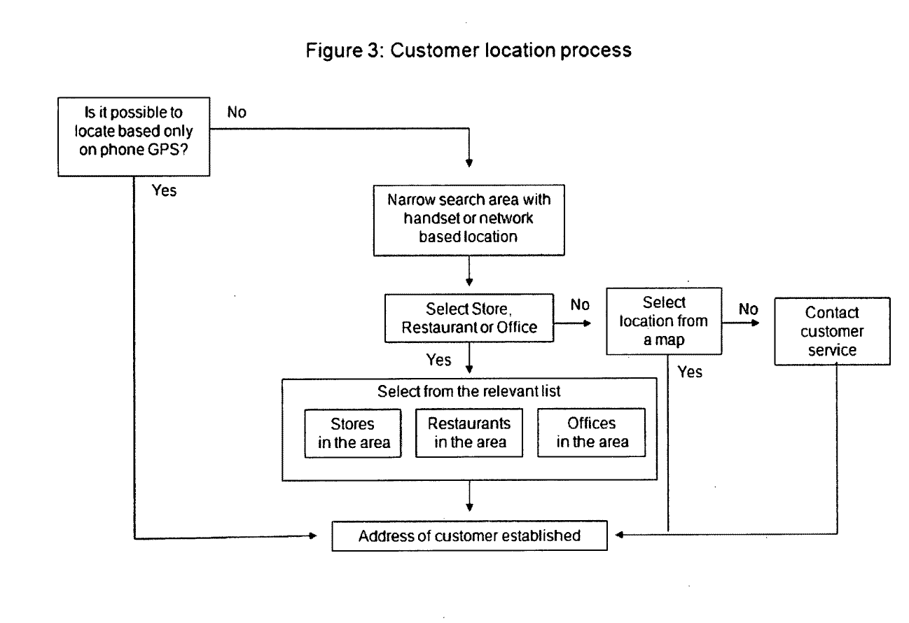

The location process (53) initiates a process to locate the cellular phone of the customer to determine the pickup location. FIG. 3 schematically illustrates an exemplary location process. The illustrated location process uses existing location functionality based on network or handset enabled location services to locate the cellular phone. If a specific address can be determined based on this process the address is inputted into the dispatching file. If a specific address cannot be determined by the cellular phone location, the customer is queried to indicate the type of location at which he is location. For instance, the location may be a restaurant, retail store or office. Based on the customer's response, the location process searches the vicinity of the cellular phone for businesses of that type and retrieves a list of businesses. The customer is queried to select his location from that list of locations and that address is entered into the dispatch file as the pickup location. If the location cannot be determined by the business location, the customer may indicate his location by selecting a location on a area map on his cellular phone. The location process will determine the nearest address to that location and enter that address as the pickup location. Failing to locate their location on the map, the customer may chose to contact a customer service representative to assist him in determining his location. The customer service representative will enter the pickup location directly into the dispatching file.

Following the determination of the pickup location, the location process locates the nearest service providers that are available to respond to the service request. The process checks the status of the service providers in their service provider profile to determine which service providers are currently available. The number of service responders that are selected for the shortlist is illustrative. These selected service providers make up a short-list of providers that may bid for the service request. If the location process cannot locate any service providers to respond to the service request, a message is sent to the customer that no drivers are available in the area and a list of taxicab companies and their contact information is provided.

The short-listed drivers receive a message that a service request has been made and the name and customer profile information, which can include their name and their customer satisfaction scores and comments. If the service provider interested in responding to the service request he will initiate the bidding process (55). The bidding process permits the drivers to submit the estimated time it will take them to arrive at the pickup location for the customer's consideration. Each short-listed service provider may enter his estimate. The estimates of all short-listed service providers are sent to the customer. The service providers' profile information such as customer satisfaction scores, timeliness ratings and comments based on previous service request performance (56) can also be sent. The short-listed service providers' ID are added to the dispatching file.

The customer reviews the short-listed service providers' bid and their customer service performance and selects a service provider to respond to his request (57). The short-listed service providers are informed that a select has been made. The Selected service provider is informed that he has been selected and receives the address of the customer and can receive, in accordance with embodiments of the present invention, customer profile information including the name of the customer (58). The service providers ID is inputted into the dispatching file. The selected service provider's status is changed to unavailable (59).

This exemplary embodiment of the present invention includes various means of tracking the progress of the service provider. The service provider's location is updated on a regular interval into the dispatching file. This information may be accessed by the customer at anytime following the selection of the service provider. The distance between the location of the service provider and the customer as calculated by a selected route may be calculated and an estimated time until arrival calculated based on that distance to the customer. The customer may query the database to inquire on the estimated time until arrival of the service provider or a countdown clock may count the minutes until arrival. Furthermore, the service provider and customer may communicate through anonymous text messaging or phone calls that allow each to send brief messages to the other. The messages could originate on the cellular phone and be redirected through the communication process to the other party. This would enable each party to originate messages to the other party without revealing their cellular phone number to the other party.

Upon arrival at the pickup location, the customer would indicate to the system that the driver has arrived, and the actual time of arrival would be entered into the dispatch file. The actual time of arrival in comparison to the estimated bid time of arrival could be used to calculate a timeliness rating for the service provider for that service request. The service provider profile would be updated with this data.

The customer initiates the tracking of the route for billing and invoicing proposes. The system could also track the journey. Following the completion of the trip the system would generate an invoice for the customer of the trip and an the cost. This invoice maybe paid through the system directly to the service provider using the billing process. The mileage, billing rates, pickup location and destination would be inputted into the invoice file and emailed to the customer or made available online.

Upon completion of the journey, the service provider and customer are queried to enter customer satisfaction scores and enter any comments related to the journey. The satisfaction scores and comments are inputted into the dispatching file for the service request and the customer and service provider performance histories in their profiles and the average satisfaction scores and timeliness rating are updated. Each party may access his service requests online and review the comments made but may not alter comments made by another party.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art.

Furthermore, methods and apparatus described herein could be used for any kind of service delivery and not limited for example to taxis. For example, this invention in another embodiment maybe used to track the delivery of goods. Food delivery could be streamlined by incorporating this invention to provide a direct ordering of food from any location. An order might be initiated using a cellular phone and tracked in real time to the door. This would be particularly useful because pizza delivery companies employ independent drivers who driver their own vehicles, so this system would be a easy way for them to utilize fleet management since they do not employ a system of company owned vehicles with GPS tracking systems installed.

Furthermore, companies providing roadside assistance could employ this system to locate customer's disabled vehicle and assist in dispatching roadside assistance to their location. The system could be employed to streamline the roadside assistance dispatching process by locating the disabled vehicle and providing a universal means of contacting assistance in any state.

In another embodiment, hospitals might coordinate personnel to respond to patient needs. Many hospitals currently employ an antiquated system of pagers to contact physician with request for medication or updates. Team leaders/doctors need to identify the needed resources and coordinate their actions immediately. This invention could be configured to list the qualifications of the hospital employees in their profiles. The team leaders could dispatch specific persons or specific groups of people with needed skills and expertise to respond to a need instantly. A group of physicians might be assigned to the care for a patient at different scheduled periods and the system might provide a means of coordinating their care and treatment over time. The system would track availability and location of all members and dispatch a specific person or elicit an alert for someone with a specific skill set or responsibility to respond immediately.

Another embodiment of the present invention can be employed to purchase and thereby create a safer, more convenient and more transparent market for tickets sold at events. Mobile brokers could post available tickets for sale. Consumers could track which tickets are available, place bids on their desires tickets, and pay the brokers through the system. This embodiment would formalize the market for tickets at events, thereby reducing the chances of fraud and allowing credit card sales for a good that is commonly paid for with cash.

All of these embodiments, and others, are within the spirit and scope of the invention. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A system for informing service providers of needed services, including:
a database that includes at least two of: records customer and service provider location, transportation service requests and service provider and customer profiles;
processing circuitry that identifies potential responders to said request, matches available responders with customer requests and performs a dispatching process including auctioning the right to provide said service, collecting and presenting service provider and customer profiles, instructing a service responder to provide transportation service identified in one said record by computing a street address to be dispatched; said processing circuitry further performing a monitoring process including reviewing service responder's activity associated with the service request; and
communication circuitry enabling the service provider to receive, review and respond to service requests and also enable the customer to review the service provider's profile, accept or deny the service provider's offer of service, monitor the service provider's activity and communicate directly with said service provider.

2. The system of claim 1 wherein said processing circuitry includes a microcomputer running a multitasking operating system, said multitasking operating system supporting both said dispatching process and said monitoring process.

3. The system of claim 1 wherein said processing circuitry includes a network of computers, one computer of said network running said dispatching process and one computer of said network running said monitoring process.

4. The system of claim 1 wherein said processing circuitry performs multiple dispatching processes in parallel and multiple said monitoring processes in parallel.

5. The system of claim 1 wherein said communications circuitry utilizes a cellular phone network to communicate with service providers and customers.

6. The system of claim 1 wherein said system will utilize cellular phones to input data into the database and initiate and respond to service requests

7. The system of claim 1, wherein said processing circuitry identifies potential service responders for a service requests based parameter including at least one of: proximity to customer and service provider historical performance and qualifications.

8. The system of claim 1, wherein said processing circuitry permits the service providers to bid for service requests.

9. The system of claim 8, wherein said processing circuitry permits bidding based on at least one of price and response time.

10. System of claim 1, wherein said processing circuitry permits the customer to review the potential service providers' bids and profile and select the provider that will respond to their request.

11. The system of claim 1, wherein said processing circuitry tracks the service provider and customer using handset enabled or network enable location technology, and said communication circuitry being operatively connected to said processing circuitry for determining service provider's activities.

12. The system of claim 1 further comprising circuitry for relaying the service provider's activity by cellular phone to said communications circuitry.

13. The system of claim 1 further comprising circuitry for relaying the service provider's and customer's profiles to said communications circuitry.

14. The system of claim 10 wherein the profiles include relevant information about the person and his previous activity including quality of performance for review.

15. The system of claim 1 wherein the processing circuitry permits the service provider to input relevant data regarding the performance of customer into the customer's profile.

16. The system of claim 1 wherein the processing circuitry permits the customer to input relevant data regarding the performance of service provider into the service provider's profile.

17. The system of claim 1 wherein said communications circuitry forwards service requests including customer location and profile data to the service responder via the communication circuitry.

18. The system of claim 1 wherein said communications circuitry forwards auction bids, profile data and activity information directly to the customer via the communication circuitry.

19. The system of claim 1 wherein the service responder may communicate directly with the customer using the communication circuitry using a double blind system so as to protect the confidential personal information from passing to the other party, and said monitoring process communicates to the customer the location and activity of the service responder.

20. The system of claim 1 wherein said the system includes circuitry for automatically transmitting a position of the cellular phone to said communication circuitry, and said monitoring process updates the progress of the service provider for the customer

21. The system of claim 1 wherein said communication circuitry respectively reads and writes communication request and response records in said database, said processing circuitry identifies service responders to provide services by writing a communication request in said database for later forwarding by said communication circuitry, and said processing circuitry obtaining service responder activity information by reading response records in said database.

22. The system of claim 1 further comprising data entry circuitry for manual operation to create a record.

23. The system of claim 22 wherein said data entry circuitry is located at a remote site in telephonic communication with said database.

24. The system of claim 22 wherein said data entry circuitry is a website and creating a record there from.

25. The system of claim 1 wherein said database, said processing circuitry and said communication circuitry are located at a plurality of locations and in telephonic communication with each other.

26. A method to provide computerized coordination of requested service to service providers, including:
storing records to document services and customer and service provider profiles;
performing a dispatching process based on the records, including locating records indicating a need for immediate service, locating the customer, identifying potential service responders, and performing an auction for the requested service and collecting a list of potential service provides with their bids and profiles;
performing a monitoring process to monitors the service provider's activities based on reviewing the records; and
updating the service provider's activity and review customer and service provider performance records in the records.
